(19) United States
(12) Patent Application Publication
(10) Pub. No.: US 2012/0197653 A1
(43) Pub. Date: Aug. 2, 2012

(54) BRAND IDENTIFICATION, SYSTEMS AND METHODS

(75) Inventors: Gregory T. Short, Carlsbad, CA (US); Geoffrey C. Zatkin, Encinitas, CA (US)

(73) Assignee: ELECTRONIC ENTERTAINMENT DESIGN AND RESEARCH, Carlsbad, CA (US)

(21) Appl. No.: 13/357,422

(22) Filed: Jan. 24, 2012

Related U.S. Application Data
(60) Provisional application No. 61/436,751, filed on Jan. 27, 2011.
(60) Provisional application No. 61/436,789, filed on Jan. 27, 2011.
(60) Provisional application No. 61/436,799, filed on Jan. 27, 2011.

(51) Int. Cl. G06Q 30/02

(52) U.S. Cl. 705/1.1

(57) ABSTRACT

Product-brand correlation engines are presented. A correlation engine seeks relationships among product-brand pairings. A user can submit a target product definition including product properties to the engine. The engine converts the target product properties into quantified metrics, which can be compared to established relationships among known products and brands. Based on the comparison the engine generates one or more possible product-brand alignments where the alignments indicate which brands would likely have beneficial or non-beneficial associations with the target product.

This application claims the benefit of priority to U.S. provisional applications having Ser. No. 61/436,789; 61/436,751; and 61/436,799 all filed on Jan. 27, 2011. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is marketing analysis technologies.

### BACKGROUND

Product recommendation systems typically track a consumer's interactions with products, a transaction for example, to determine if another product might be of interest to the consumer. More advanced systems track populations of consumers and their interactions with products to generate product recommendations for members within the population. Such systems are useful to product vendors or product brand owners to increase exposure of their branded products. However, in an environment where products can be cross-branded (e.g., SpongeBob SquarePants® Colgate® toothpaste, Dora the Explorer® Candyland® board game, etc.), product recommendation systems fail to provide insight into which brands could be beneficially combined or aligned with a product or other brand to enhance exposure, revenue, reviews, or other market related metrics.

Some effort has been put forth toward aligning product strategy with a brand strategy. For example, U.S. patent application publication 2007/0192170 to Cristol titled “System and Method for Optimizing Product Development Portfolios and Integrating Product Strategy with Brand Strategy”, filed Apr. 3, 2007, describes assessing a client's brand and product strategies and determining a market impact from brand alignments. Although useful for estimating a market impact, Cristol fails to offer a path to determine which brand or brand type would be best for a product, especially when the products and brands are owned by different entities.

U.S. patent application publication 2010/0076844 to Christiansen et al. entitled “Advertising System and Method”, filed Mar. 26, 2009, makes some progress. Christiansen discusses matching branding parameters of brand clients with content. The content can then be presented to consumers based on matching the branding parameters with the consumer's preferences. Although Christiansen matches content with brand, Christiansen fails to provide for recommending a brand-content alignment, let alone a brand-product alignment.

Still further, U.S. patent application publication 2010/0179874 to Higgins et al. entitled “Media Object Metadata Engine Configured to Determine Relationships between Persons and Brands”, filed Jan. 13, 2009, discusses determining relationships between a brand represented in a media object (e.g., an image) and people associated with the media object (e.g., imaged person, photographer). If a relationship is found, then an advertisement can be sent to the people based on the observed brands. Higgins also lacks insights into providing brand-product alignments.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Thus, there is still a need for a system to better support the identification of relationships between products and brands.

### SUMMARY OF THE INVENTION

The inventive subject matter provides apparatus, systems and methods in which products and brands are classified at a highly granular level. One aspect of the inventive technology includes a brand-product correlation engine capable of establishing possible relationships among brand-related metrics and product-related metrics. Correlation engines can include one or more databases including a brand database storing brand objects and a product database storing product objects. The brand objects and product objects can comprise one or more metrics, preferably normalized to a common namespace, via which brand objects can be compared to product objects. The correlation engine can further include a product interface through which a user can submit a target product, including target product properties. A normalization engine converts the target product's properties into target product metrics according to the normalized namespace rules. Preferably the correlation engine further comprises a recommendation engine capable of generating a recommended brand alignment with the target product. The recommendation engine can be configured to establish relationships among known product objects and brand objects based on their respective object metrics. The recommendation engine can use the relationships in combination with the target product metrics to derive one or more brand-product or product-brand alignments. The recommendation engine can further configure an output device, the product interface for example, to present the alignments.

The concept of brand is considered to have far reaching themes. Brands can include corporate brands, celebrity, franchises, logos, names, or other marketable characteristics that can be identified by a market place (e.g., consumers, vendors, publishers, etc.).

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of brand-product correlation ecosystem.

FIG. 2 illustrates converting brands or products into objects having object metrics.

FIG. 3 presents an example chart showing relationships among brand and product object metrics.

### DETAILED DESCRIPTION

It should be noted that while the following description is drawn to a computer/server based brand-product analysis systems, various alternative configurations are also deemed suitable and may employ various computing devices including servers, platforms, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing a communication infrastructure through which product providers can match their products with possible brands.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, within a networking context, “coupled” is also considered to include communicatively coupled networked elements (e.g., servers, processors, devices, computers, databases, etc.).

External metrics such as consumer awareness, sales performance, or demographic information can be integrated and aligned with both the brand and the product. After processing this data to achieve optimal relationships between the data sets it is then possible to isolate out specific brands and products as they relate to each other to create optimal bi-directional inferences to assist in the marketing and business decisions of brand or product owners.

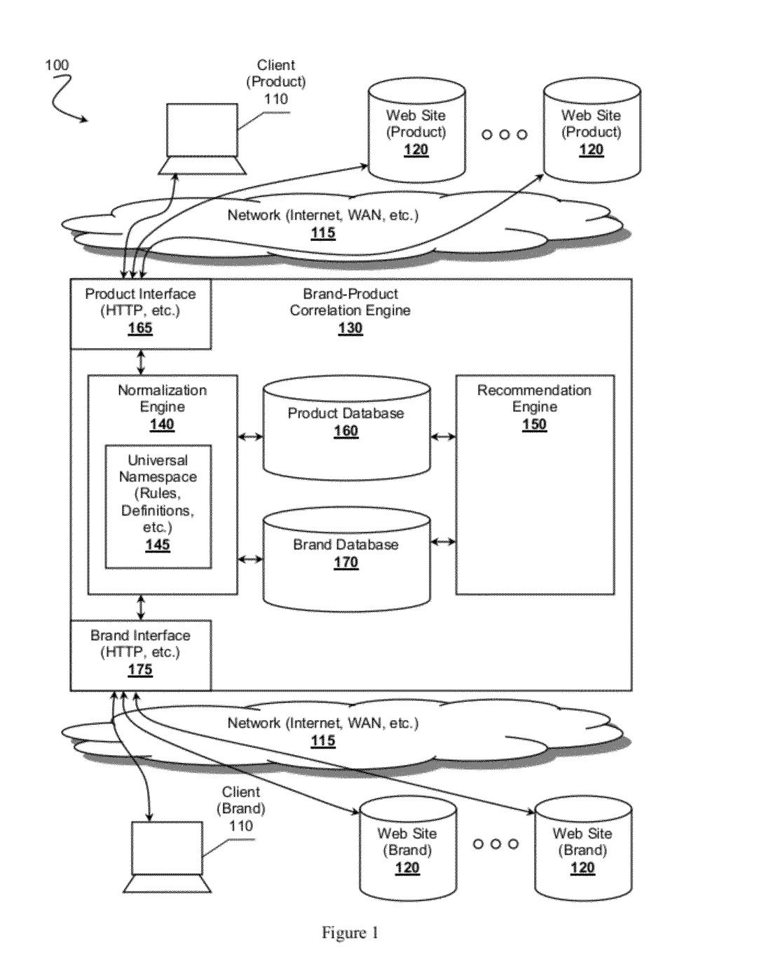

In FIG. 1 illustrates ecosystem 100 where brand-product correlation engine 130 provides an indication if products or brands are recommended or not recommended to be aligned with each other. Further, correlation engine 130 can present one or more product-brand alignments that could impact one or more market related parameters (e.g., revenue, buzz, review scores, market penetration, serviced available markets, etc.). Brand product correlation engine 130 preferably operates as a service, possibly a for-fee service operating on an Internet-based server, to one or more clients 110 where clients 110 could include product providers or even brand owners. Product providers can access services offered by correlation engine 130 through product interface 165. In a similar vein, brand owners can also access the services via brand interface 175.

Brand-product correlation engine 130 comprises a computer-based system, possibly operating on the Internet as a web service. In some embodiments, correlation engine 130 can operate within a cloud-based environment. For example, correlation engine 130 could be deployed within the Google® cloud via the Google App Engine, Amazon® EC2, IBM® cloud servers, Rackspace® servers, or other cloud based systems. Although correlation engine is illustrated as an Internet-based computer system, one should appreciate that the engine's or its components roles or responsibilities can be distributed among elements within ecosystem 100. In some embodiments, a computer owned or operated by clients 110 could execute application software capable of configuring the computer to behave has normalization engine 140, correlation engine 130, or recommendation engine 150.

In a preferred embodiment recommendation engine 150 operates as a service on an on-line computer system. Still, it is also contemplated that recommendation engine 150 could leverage a mechanical turk model where one or more real people aid in providing recommendations. For example, an interface could be provided to the masses which allow many individuals to submit recommendations. The submitted recommendations can be aggregated statistically to build a recommended alignment. One could consider such an approach as a mass mob focus group. Amazon's mechanical turk infrastructure (see URL www.mturk.com/mturk/welcome) could be adapted for use with the inventive subject matter.

Product or brand clients 110 could access the services offered by correlation engine 130 through a dedicated application or via a web interface (e.g., HTTP server) as indicated by product interface 165 or brand interface 175. Client 110 can leverage the interfaces to manage their accounts on correlation engine 130, manage their product portfolios or brand portfolios, or otherwise manage their interactions with correlation engine 130. For example, a product client 110 could log on to correlation engine 130 and submit one or more target product definitions, each target product having one or more target product properties. Correlation engine 130 can use the target product information to conduct an analysis. In a similar vein, a brand owner could submit one or more target brand definitions to correlation engine 130 via brand interface 175. Still, further correlation engine 130 can interact with clients 110 via brand interface 175 or product interface 165 by presenting resulting analysis, reports, interfaces, or other possible points of interaction. As depicted correlation engine 130 or its sub-components of (e.g., recommendation engine 150, normalization engine 140, etc.) can configure an output device (e.g., remote computer/browser, printers, displays, etc.) to present derived alignments between products and brands to clients 110.

An astute reader will recognize the symmetry between products and brands. The disclosed techniques can be applied to discovering alignments between a target product and a known brand, or between a target brand and a known product. In both cases, products and brands are considered goods, services, items, monikers, logos, or other properties having market value. Further, the products can include tangible items (e.g., physical goods), or intangible items (e.g., trademarks, virtual goods or services, patents, licensable property, etc.) or non-physical items. Still, products are considered to be weighted toward goods or services, while brands are considered to be weighted toward more intangible items. Example brands can include corporate names, celebrity, franchises, logos, names, or other marketable characteristics.

Product interface 165 and brand interface 175 are presented as one or more HTTP servers communicatively coupled with correlation engine 130. Clients 110 can interface via the HTTP servers using proprietary or known protocols including HTTP, HTTPS, SSL, SSH, TCP/IP, WSDL, XML, SOAP, or other types of protocols. Further interfaces 165 or 175 could take on other forms. For example, interfaces 165 or 175 could operate as an Application Program Interface (API), database query interface, or other types of interfaces capable of exchanging data between correlation engine 130 or its components over networks 115. Although product interface 165 and brand interface 175 are illustrated as two distinct interfaces, in some embodiments they can utilize the same interface (i.e., the same HTTP server).

Correlation engine 130 can also leverage product interface 165 or brand interface 175 to obtain product or brand information from web sites 120 over network 115. Correlation engine 130 can crawl across multiple web sites 120 searching for product or brand information, which can be assimilated or otherwise compiled within product database 160 or brand database 170. For example, correlation engine 130 could search for celebrities on remote web sites 120 possibly including blogs, entertainment sites, news sites, or other types of remote information providers. As correlation engine 130 obtains the product or brand information, normalization engine 140 applies one or more rules associated with a universal namespace to convert the acquired product or brand properties into a one or more corresponding metrics. Correlation engine 130 preferably utilizes universal namespace 145 to allow for direct comparison between one type of object in the system and other types of objects.

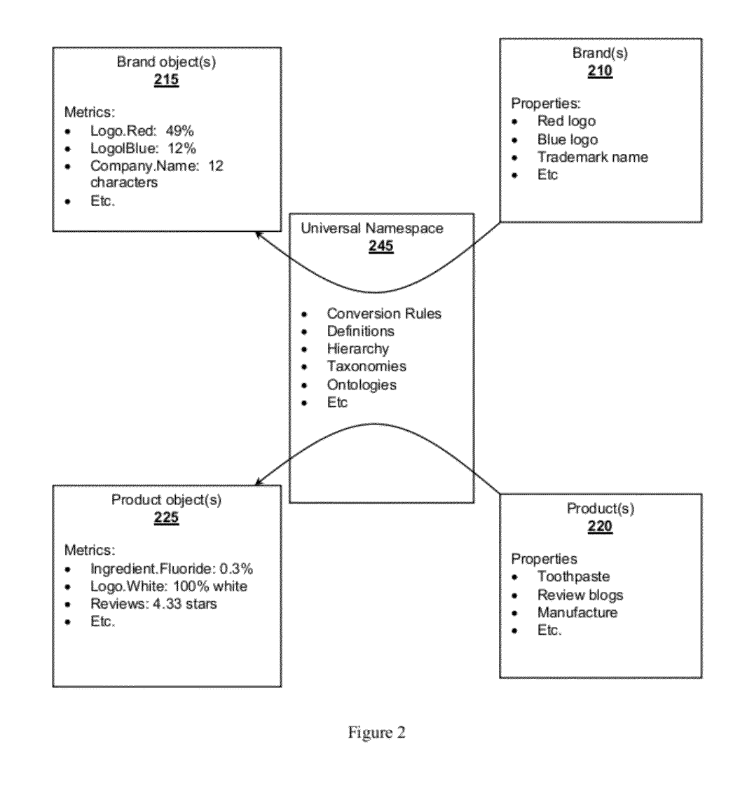

Normalization engine 140 leverages universal namespace 145 to quantify product or brand properties obtained from web sites 120, or from brand or product clients 110. For example, correlation engine 130 can scan a product review site having a review score rated in stars. The review score can be converted or normalized to a value range that can be readily compared to other review scores that might rate products, or brands, based on scales from 1 to 10, based on a distribution, or an absolute ranking Quantified object properties are considered to be metrics having a measurable or concrete value. Example metrics can include sales figures, product dimensions, product shapes, names, amount of color associated with the item, demographic profiles, or other types of quantifiable information. It is contemplated that a single product or brand object could have thousands of metrics associated with it. Additional discussion regarding product or brand metrics can be found below with respect to FIG. 2.

Product or brand metrics are bound to product objects and brand objects, respectively. Each product object is preferably stored in product database 160 as a distinct manageable object. Similarly each brand object is stored in brand database 170 as a distinct manageable object from other brand objects and from product objects. One can consider each distinct manageable object as a multi-valued data structure having attributes and associated attribute values describing the properties or characteristics of the corresponding object. In some embodiments, the objects can be stored as an N-tuple of information where each data member can be analyzed relative to each other data members. Further, data member names or attributes can be named according the universal namespace 145. Although product database 160 and brand database 170 are illustrated as distinct databases, they could be combined into a single database system. In such an embodiment, each type of object can be distinguished from each other by a namespace attribute identifying the object as a product, a brand, a good, a service, or other type of item.

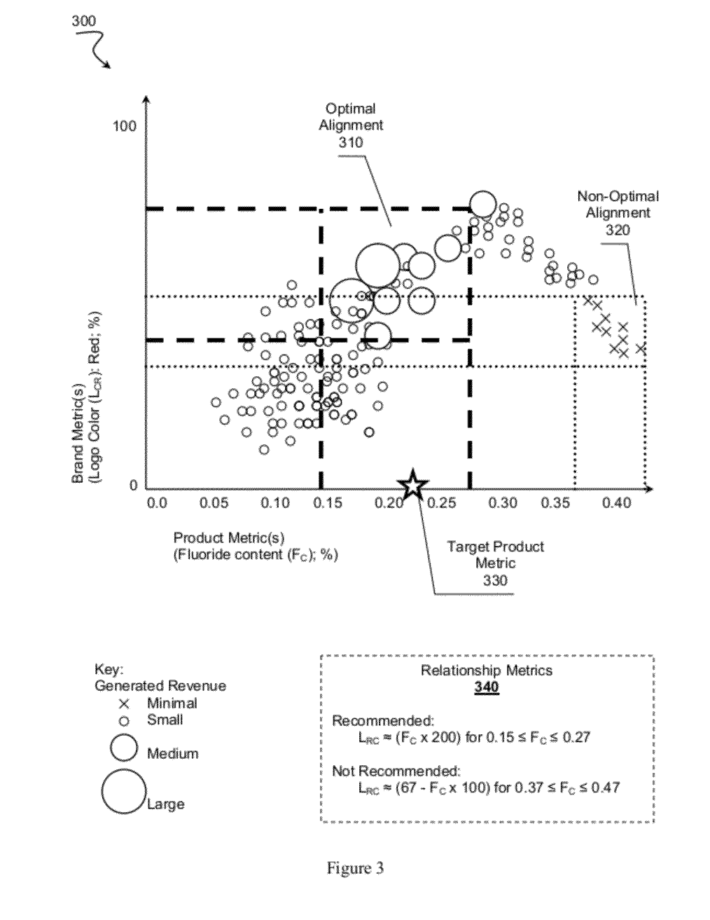

In some scenarios, a product and brand are associated with the same object. For example, a style of shoe can be bound with a brand (e.g., Converse® Chuck Taylor hi tops). As discussed above, a single object can include attributes conforming to universal namespace 145 rules where the corresponding attributes identifies the product as well as the brand bound to the product. Thus, the system can track how the product's attributes or metrics can be compared with a brand metrics. Through such comparisons, especially across many product and brand pairings, recommendation engine 150 can discover if there are relationships among the products and brands. If recommendation engine 150 derives a relationship, then recommendation engine 150 can conduct an analysis on how a target product, or a target brand, can be aligned with other objects regardless of type. Discovered or derived relationships can be quantified as one or more relationship metrics as discussed with respect to FIG. 3 below.

Recommendation engine 150 analyze products object and brand objects to seek if there are relationships or correlations among product or brand metrics. Recommendation engine 150 can use one or more techniques to discover relationships. Example techniques can include multi-variate analysis, cluster plots, inference reasoning (e.g., inductive, abductive, deductive, case-base reasoning, etc.), genetic algorithms, simulated annealing, or other types of approaches that can seek out possible correlations.

When product is bound to a brand, or vice versa, clients 110 might find it useful to create a comparison or contrast of a target product with or without the bound brand. Consider SpongeBob SquarePants Colgate toothpaste as an example. Client 110 can conduct an analysis of Colgate toothpaste as a generic product versus the identical product branded with SpongeBob SquarePants to identify possible unexpected interaction points between product metrics or brand metrics. Such analyses would likely show that the SpongeBob toothpaste packaging having a high percentage of yellow packaging, thus indicating a possible correlation between yellow packaging and the SpongeBob name. However, it would also be beneficial to identify that the normal product packaging colors might correlate with SpongeBob demographics to begin with before the association is made. Through such analysis, client 110 can use the system to assess how a brand association can impact marketability of a product before, during, or after product-brand association is established.

As mentioned above, when recommendation engine 150 establishes one or more relationships, recommendation engine 150 can further establish one or more relationships metrics that quantify how products and brands are related. The relationship metrics can be simple to complex in form. Example metrics can include linear relationships, non-linear relationships, or other types of relationship. Further, a relationship metric can also depend on time. As product or brand properties change, corresponding brand or product metrics can change, which can then be reflected back into the relationship metrics.

Relationship metrics can also be validated through one or more possible approaches. One approach is to establish one or more relationship metrics based on a small sample size of the available data including product objects and brand objects. The relationship metrics can then be compared against a second portion of the data sets to see if the relationship can be re-derived, at least to within an error threshold, or check to see if the relationship metric can be successfully applied. Yet another approach can include storing the relationship metrics for a period of time to determine if future released products/brands conform to the relationship metrics.

The correlations among brands and products can also be used to establish second, tertiary, or higher order relationship metrics. For example Brand B might have a relationship with a cluster of products having a common product metric C and with a second cluster of products having a metric D. The two products, or brands for that matter, could be considered related via Brand B. Such a bridging relationship might indicate the products having metric D might be indirectly associated with products having product metric C. Thus, a chain of relationships can be established.

Clients 110 can submit one or more products through product interface 165 where product interface 165 is configured to accept target product and associated target product properties. Normalization engine 140 converts the target product properties into target product metrics. Then, recommendation engine 150 uses the target product metrics with the relationship metrics to generate an alignment between the target product and at least one brand. The alignment can include a positive alignment (e.g., recommended that the product should be aligned with the brand) or a negative alignment (e.g., recommended that the product should not be aligned with the brand). Further, a strength of the alignment can be provided where the strength can be measured based on the statistical size of the data sample, fit of a model to the data, number of aligning metrics, or other factors.

FIG. 2 illustrates how product or brand information can be obtained and converted into brand objects 215 or product objects 225. The correlation engine can seek out information associated brand 210 or product 220 possibly by crawling remote web sites as discussed previously. Brands 210 or products 220 are considered to include one or more properties outlining various aspects about the items. As the information is obtain, the correlation engine can apply the conversion rules, definitions, taxonomies, ontologies, or other aspects of the universal namespace 245 to create product or brand metrics as indicated.

In view that the correlation engine can obtain product or brand properties at any time, one should appreciate that the corresponding product or brand metrics can change with time. In some embodiments, the correlation engine tracks metric changes in time for product object 225 or brand object 215.

In the example shown, universal namespace 245 represents rules, definitions, or other parameters used to convert from generic, publicly available information or information provided by a client into a common namespace within the system. Universal namespace 245 can be constructed according to many different techniques. In some embodiments, namespace 245 can be based on one or more taxonomies, ontologies, image or audio recognition algorithms, hierarchies, or other types of namespaces. For example, namespace 245 could leverage existing standardized ontologies possibly based on eClassOWL for products or services (see URL www.heppnetz.de/projects/eclassowl/) or other known ontologies or taxonomies. Further, in some embodiments, the common universal namespace 245 can also be proprietary. Still, further the system can leverage more than one namespace 245 where at least some of the brand objects 215 or product objects 225 could have metrics that are mapped to multiple namespaces 245. The multiple namespaces 245 could include overlapping namespace or non-overlapping namespaces. Such an approach is considered advantageous when there are significant differences in marketplace terminologies or descriptions. One should note universal namespace 245 does not necessarily have to be human-readable, but could be machine readable. In such a case where namespace 245 is computer readable, each concept in the namespace could be assigned a concept identifier (e.g., a GUID, hash value, etc.) to represent the metric or attribute. Further, the system can include a translation tool capable of converting the concept identifiers to a human readable form.

Universal namespace 245 can also be considered a dynamic namespace that changes with time. The rules, definitions, taxonomies, ontologies, or other constructs composing namespace 245 can change with time. As a result, metrics associated with brand objects 215 or product objects 225 can also change to reflect the changing of namespace 245. One reason that namespace 245 would change is to reflect a change in cultural norms, language, or shifts in a market space. In view that namespace 245 can change one aspect of the inventive subject matter includes capturing a snap shot of namespace 245 in time and storing the snap shot in a namespace database. For example, a snap shot of namespace 245 could be created on a yearly basis so that future products or brands can be compared to past products or brands.

In a preferred embodiment the correlation engine uses namespace 245 to convert product or brand properties into quantified metrics as illustrated. As an example considered a scenario where a brand object corresponds to a logo. A normalization engine creates a logo attribute and analyzes the logo for relevant metrics. In the example show, the analysis indicates that a logo comprises 49% red and 12% blue, possibly detected through an image recognition algorithm (e.g., SIFT, color histograms, etc.). Such values can be measured empirically from on-line photographs, audio recordings, text data, or could even be entered directly from a brand owner. Similarly, product objects can also have quantized metrics.

Quantified object metrics can include just about any measurable value or values, including numbers, strings, literals, Booleans, or other data values that can be compared with other values. Further, metrics can be single valued, multi-valued, or have multiple dimensions (e.g., a vector, matrices, etc.). In the examples, the metrics include a percentage of color, number of characters in a name, ingredients, or reviews scores. All possible metrics are contemplated.

Preferably the namespace 245 normalizes the metrics so that they can be readily compared. For example, if the brand or product information includes review scores then the scores can be normalized to a common scale. For example, a five star scale could be normalized to a value of 1 through 10, or 1 through 100 where the range is defined by namespace 245. Further, if a review score represents an absolute number, possibly a number of thumbs up or +1s, the score can be a stand alone metric or normalized against a view count to generate a value between 0 to 1, or 1 to 100 or other normalized scale. The normalization engine can also add appropriate weights to a obtained values when normalizing to namespace 245.

The correlation engine can use the quantified metrics as a basis for a comparison analysis of brand objects 215 and product objects 225. The correlation engine seeks to find one or more correlations and establish relationships between the brand metrics and product metrics.

FIG. 3 provides an illustrative example of a fictional analysis where the correlation engine attempts to find a relationship between one or more brand metrics and one or more product metrics. In the example shown, chart 300 compares a brand metric representing an amount of red color associated with a brand's logo against a product metric of toothpaste Fluoride content. One should appreciate that chart 300 is presented as an example only. Chart 300 is also presented in a human readable form, while the correlation engine does not necessarily require a chart unless requested by a client or other user. Target product metric 330 represents a value for a product under consideration, in this example a toothpaste product having a Fluoride content of about 0.23%. Further, chart 300 represents a two dimensional chart presenting various brand-product pairing data points. In some embodiments, the data points can be processed or analyzed with any dimensionality.

In chart 300 each data point represents a product-brand pairing where the type of data point indicates an amount of revenue generated for the product. Revenue can be considered a third dimension to the data point beyond amount of red in a logo and Fluoride content. Although revenue is used in this example, an additional dimension of the plot beyond revenue could be any other metric as well (e.g., product metric, brand metric, etc.). For example, each data point could represent buzz, market penetration, review scores, demographic, or other metrics. One should keep in mind that brand objects and product objects can be considered N-tuples of information where any member of the N-tuple can be plotted or analyzed against one or more other members.

One should also appreciate that a relationship can be a positive, neutral, or negative relationship. When relationship metrics 340 indicate a strong, positive relationship, a recommendation can be generated in the form of an alignment of the target product object with a brand corresponding to a brand object; a golf game can be associated with Tiger Woods for example. The reverse can also be true. A recommendation can also include aligning a brand with a product; Nike can be aligned with an extreme sports video game for example.

Relationships that are negative, yet strong might indicate a non-optimal relationship. Thus the product objects and brand objects would likely fail to benefit from an alignment. Furthermore, one should appreciate that the relationships can be directional. Even though a product is considered to have a strong, negative relationship with the brand where the product might suffer from such a relationship, the brand might benefit from such a relation. For example, a negative reviewer might want to give a bad review to a popular game because it will increase his hit count. The strong negative alignment is beneficial to the reviewer.

The correlation engine seeks to identify one or more relationship metric 340 associated with the brand objects and product object. In the example, the correlation engine has identified two relationship metrics 340 that have a linear relationship. The first corresponds to a recommended optimal alignment 310 and the second corresponds to a non-recommended non-optimal alignment 320. Optimal alignment 310 represents a region within the data space having a positive, possibly a strongly positive, correlation. Non-optimal alignment 320 includes a region where there is a strongly negative correlation between product objects and the brand objects. When client submits a new target product to be analyzed, the correlation engine can compare the target product's metrics 330 to the relationships metrics 340 to determine a set of brand metrics that are recommended on not recommended. For example optimal alignment 310 would indicate that a target product having target product metric 330 of 0.23% Fluoride content might be best suited to a brand having a color logo that is roughly 50% red. Further, the non-optimal alignment 320 would indicate that the toothpaste product having target metric 330 should most definitely not be associated with a brand having a red logo in the 30% to 40% range.

Although optimal alignment 310 and non-optimal alignment 320 are presented as regions within a graph, one should appreciate that an alignment is considered a manageable object within the correlation ecosystem. In some embodiments, alignments can include properties representative of relationship metrics 340, possibly in the form instructions that can be used to configure a display, or other output device, to present the alignments. For example, a product provider using the correlation engine might receive a visual report presented within a browser where the report includes possible graphical representations of relationship metrics 340 or other alignment properties. Contemplated alignment properties can include quantified values representing indications that a target product should be associated with a brand object, indications of the strength of alignment (e.g., optimal, non-optimal, on a scale, etc.), indications alignment direction (e.g., positive, negative, neutral, value, etc.), or indications of quality of alignment (e.g., confidence level, etc.).

Each quantified alignment property can be calculated through various techniques. For example, a strength of an alignment could be calculated from a λ² value obtained from a fit of relationship metric 340 to the data. Other types of calculated values can also be mapped to alignment properties including calculated or measured errors, probabilities, confidence levels, results from Monte Carlo simulations of fits, or other quantified values.

The alignment preferably includes one or more brands that satisfy relationship metrics 340. Each brand within the alignment can be presented to a user according to a ranking where the brands are ranked by one or more of the quantified alignment properties. For example, brand associations can be presented according to strength of association, number of brand metrics falling with in an alignment region of interest, or other factors.

The recommendation engine can also be responsive to data entering or leaving the databases. As product or brand metrics change, the recommendation engine can update its recommendations or relationship metrics according, possibly in real-time. In such embodiments, the recommendation engine can also present recommendations or relationships as a function of time, which can be used as a leading indicator of a developing relationship. If a leading indictor satisfies triggering criteria, corrective actions, if desired, can be taken to enhance or hinder the growing relationship.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A brand-product correlation engine, the engine comprising:
a brand database storing a plurality of brand objects, each brand object having brand metrics classified according to a universal common namespace;
a product database storing a plurality of known product objects, each product object having product metrics classified according to the universal namespace;
a product interface coupled with the product database and configured to accept a target product with target product properties;
a normalization engine coupled with the product interface and configured to convert the target product properties into target product metrics according to the universal common namespace, and to store the target product metrics in the product database; and
a recommendation engine coupled with the product database and the brand database, and configured to:
establish relationship metrics among the product objects and brand objects, the relationship metrics derived as a function of the brand metrics and product metrics;
generate an alignment between the target product and at least one brand object based on the target property metrics relationship metrics; and
configure an output device to present the alignment of the target product with the at least one brand object.

2. The engine of claim 1, where the alignment comprises an optimal alignment as reflecting a strong, positive relationship between the target product and the at least one brand object.

3. The engine of claim 1, where the alignment comprises a non-optimal alignment as reflecting a strong, negative relationship between the target product and the at least one brand object.

4. The engine of claim 1, wherein the recommendation engine is further configured to adjust the relationship metrics based on changes to the product properties within the product database.

5. The engine of claim 4, wherein the relationship metrics are updated in real-time.

6. The engine of claim 1, wherein the alignment indicates the target product should be associated with the at least one brand object.

7. The engine of claim 1, wherein the alignment indicates the at least one brand object should be associated with the target product.

8. The engine of claim 1, wherein target product represents a licensable property.
